(19) United States
(12) Patent Application Publication
(10) Pub. No.: US 2006/0290795 A1
(43) Pub. Date: Dec. 28, 2006

(54) Image pickup apparatus

(76) Inventor: Hiroshi Itoh, Tokyo (JP)

Correspondence Address: STRAUB & POKOTYLO, 620 TINTON AVENUE, BLDG. B, 2ND FLOOR, TINTON FALLS, NJ, 07724, US

(21) Appl. No.: 11/512,533

(22) Filed: Aug. 29, 2006

Related U.S. Application Data
(62) Division of application No. 10/331,293, filed on Dec. 30, 2002.

(30) Foreign Application Priority Data
Jan. 11, 2002 (JP) 2002-4057

(51) Int. Cl. H04N 9/64

(52) U.S. Cl. 348/246

(57) ABSTRACT

An image pickup apparatus is constructed as including: a taking lens; CCD image pickup device for converting object light into electrical signals; AD converter for converting image pickup signals into digital signals; a defect detecting section for detecting defect pixels in the digital image pickup signals; a defect correcting section for performing correction processing of the defect pixels detected at the defect detecting section; and a system controlling section for managing the operation of the entire system. The taking lens is attachable/detachable and interchangeable and a function is provided at the system controlling section to detect attachment/detachment of the taking lens. The defect detecting section is caused to perform defect detection when the taking lens has been detached so that the power consumption is reduced and at the same time a missing of image taking chance due to defect detection is prevented.

### RELATED APPLICATIONS

This application is a divisional application of U.S. patent application Ser. No. 10/331,293 (titled “IMAGE PICKUP APPARATUS,” filed on Dec. 30, 2002, listing Hiroshi Itoh as the inventor), which claims benefit of Japanese Application No. 2002-4057 filed in Japan on Jan. 11, 2002. The contents of these applications are incorporated by this reference.

### BACKGROUND OF THE INVENTION

The present invention relates to image pickup apparatus in which a suitably taken image can be obtained by detecting defect pixels occurring at image pickup device such as a solid-state image pickup device.

In recently developed image pickup apparatus, solid-state image pickup devices typically represented by CCD are commonly used as an image input device. A solid-state image pickup device is an aggregate of several millions of very small pixels and an input light is converted into electric charge at each pixel and is outputted as image signal according to the amount of the light. Of such a solid-state image pickup device, the individual pixels can never be provided with uniform characteristics in manufacture. Defect pixels result and are known to cause an extreme deterioration of image quality when the difference in such characteristics becomes conspicuous. Among the methods long known as the technique for dealing with such defect pixels in the image pickup apparatus having solid-state image pickup device mounted thereon is the following method. In particular, there is a known method in which addresses of the pixels previously detected as defect are stored to an exclusive memory so as to perform correction with respect to the pixels of the predetermined addresses while referring to outputs from the memory.

With this method, however, it has been impossible to deal with those posterior defect pixels occurring for example due to electrostatic breakdown after the shipment of the image pickup apparatus, since the locations of defect pixels are stored to a non-volatile memory in the manufacturing process of the image pickup apparatus. A defect correcting technique as will be explained below has been known as the method for solving such problem. In particular, Japanese patent laid-open application No.6-6685 discloses a defect correcting apparatus which has a means for storing data of defects of fault pixels detected at a defect detecting circuit at the time of turning-on of the power and includes a circuit for correcting image pickup outputs from the solid-state image pickup device on the basis of the data of defects from the storage means when an image is to be taken.

Further as a detection method for detecting the subsequently occurring defect pixels, the following method is known. In particular, Japanese patent laid-open application No.6-245148 discloses a defect pixel correcting apparatus having a defect detection means in which correlation operation is performed at the defect detection means for a subject pixel of detection in relation to the surrounding four pixels, i.e., two pixels each adjacent thereto on the two sides thereof in the same horizontal line within the image signals to determine whether the subject pixel of detection is a defect pixel or not. If it is a defect, a predetermined defect detection signal is outputted to a defect correcting section provided also in the apparatus so as to correct the pixel which has been determined as defect.

The defect pixel correcting technique disclosed in that publication will be described below by way of FIG. 1. It should be noted that, while defect pixels include black spot defects where the sensitivity is lower than the surrounding normal pixel values and white spot defects where, conversely, the level becomes higher than the surrounding normal pixel values, the explanation in the following will be made by exemplifying the detection of white spot defects. The image pickup signals photo electrically converted by CCD image pickup device 101 after transmitted through a lens 100 are digitized by an analog-to-digital converter 102 and inputted to a detecting circuit 103 and correcting circuit 104. At the detecting circuit 103, an observed pixel signal yn and two pixel signals each before and after, i.e., yₙ₋₂, yₙ₋₁,yₙ₊₁, yₙ₊₂ are obtained by flip-flops 105, 106, 107, 108. The following operation is then performed with respect to these pixel signals by subtracters 109, 110, 111, 112 and comparison circuits 113, 114, 115, 116.

Yₙ−yₙ₋₁>a₁, yₙ−yₙ₊₁>a₂, yₙ₋₂−yₙ₋₁>b₁, yₙ₊₂−yₙ₊₁>b₂

Here a₁, a₂, b₁, b₂ are thresholds for detecting defects. A pixel satisfying all of these conditions is determined as defect through an AND circuit 117. Such defect detection output is delivered to the correcting circuit 104 so that only the defect pixel is corrected as replaced by a value computed from neighboring pixels.

With the defect correcting apparatus as disclosed in the above mentioned Japanese patent laid-open application No.6-6685, however, the defect detecting operation is performed every time when the power is turned on despite the fact that, in actuality, the pixels subsequently becoming defects are not so frequent. This results in the problems that more power is consumed and there is a greater waste in the starting time required before making photographing possible.

Further, with the method disclosed in Japanese patent laid-open application No.6-245148 as mentioned above, it is difficult to apply fixed thresholds a₁, a₂, b₁, b₂ to the detection of defects of an arbitrary object, since the accuracy in defect detection is influenced by the conditions for example of frequencies and shape of the object. For this reason, it has been necessary in actuality that the defect detecting operation be performed under certain object conditions for example by cutting off light. Conversely, when they are applied to an arbitrary object in operation, there are many cases where normal pixels are detected as defects or fault pixels cannot be detected as defects. In such case, there is a problem of deterioration in the original image quality.

### SUMMARY OF THE INVENTION

To eliminate the above problems in the conventional defect pixel detecting/correcting methods, it is an object of the present invention to provide an image pickup apparatus having a defect pixel detecting/correcting function in which power consumption and starting time required before making image taking possible are reduced and at the same time the operability such as for not missing an image taking chance Is improved.

In accordance with a first aspect of the invention, there is provided an image pickup apparatus including: a taking lens; an image pickup device; and defect pixel detection means for detecting defect pixels occurring on the image pickup device; wherein the defect pixel detection means detects defect pixels in a time period during which an image taken by main exposure requiring a recording by the image pickup device cannot be obtained.

In thus constructed image pickup apparatus, the starting time required before making image taking possible can be reduced as compared to the method where defects are detected at every turning-on of the power. Accordingly, the operability can be improved with a less likelihood of missing an image taking chance due to defect detection.

In accordance with a second aspect of the invention, the image pickup apparatus according to the first aspect further includes: an interchange mechanism of the taking lens; and taking lens interchange operation detection means for detecting an interchange operation of the taking lens; wherein the defect pixel detection means detects defect pixels when the taking lens interchange operation detection means has detected the interchange operation of the taking lens. In accordance with a third aspect of the invention, the image pickup apparatus according to the first aspect further includes: dust removal means for removing dust adhering to a light receiving surface of the image pickup device; and dust removing operation detection means for detecting a dust removing operation by the dust removal means; wherein the defect pixel detection means detects defect pixels when the dust removing operation detection means has detected a dust removing operation of the dust removal means.

In either case of thus constructed image pickup apparatus, the defect detecting operation is to be performed less frequently than the case of every turning-on of the power so that the operability is improved and a reduction in power consumption becomes possible. Further a missing of image taking chance due to the defect detecting operation is avoided.

In accordance with a fourth aspect of the invention, the image pickup apparatus according to the first aspect further includes: connection means for electrically connecting in a detachable/reattachable manner an external storage medium for recording image; and attachment/detachment detection means for detecting a presence of attachment/detachment of the external storage medium to the connection means; wherein the defect pixel detection means performs defect detection when the attachment/detachment detection means has detected that the external storage medium is not yet attached to the connection means. In accordance with a fifth aspect of the invention, the image pickup apparatus according to the first aspect further includes: connection means for electrically connecting in a detachable/reattachable manner an external storage medium for recording image; and blank capacity detection means for detecting a blank capacity of the external storage medium; wherein the defect pixel detection means performs defect detection in an operation period during which the blank capacity detection means detects the blank capacity of the external storage medium.

In accordance with a sixth aspect of the invention, the image pickup apparatus according to the first aspect further includes: connection means for electrically connecting in a detachable/reattachable manner an external storage medium for recording image; and transmission period detection means for detecting an image data transmission period to the external storage medium; wherein the defect pixel detection means performs defect detection in a period during which the transmission period detection means is detecting an image data transmission period. In accordance with a seventh aspect of the invention, the image pickup apparatus according to the first aspect further includes: a diaphragm; means for controlling operation of the taking lens and the diaphragm; and taking lens/diaphragm operation detection means for detecting an operation of the taking lens or the diaphragm; wherein the defect pixel detection means performs defect detection in a period during which the taking lens/diaphragm operation detection means is detecting that the taking lens or the diaphragm is in operation.

In any of the image pickup apparatus constructed as in the above fourth to seventh aspects, defect detection can be performed at times other than the image taking operation intended by the photographer without regard to turning-on of the power so that an efficient fault detection can be performed without missing an image taking chance due to the defect detection.

In accordance with an eighth aspect of the invention, the image pickup apparatus according to the first aspect further includes an incident light condition detecting means for detecting the condition of incident light onto the image pickup device, wherein the defect pixel detection means detects defect pixels when a condition that light incident on the image pickup device is very small in amount is being detected by the incident light condition detecting means. In accordance with a ninth aspect of the invention, the image pickup apparatus according to the eighth aspect further includes a light cutoff means for cutting off incident light onto the image pickup device, wherein the incident light condition detecting means detects the condition of a very small amount of the incident light onto the image pickup device by condition where light is cut off by the light cutoff means. In accordance with a tenth aspect of the invention, the image pickup apparatus according to the eighth aspect further includes a mechanism capable of switching the optical path of the incident light onto the image pickup device, wherein the incident light condition detecting means detects the condition of a very small amount of the incident light onto the image pickup device by the fact that the optical path is being switched to an optical path different from the optical path to the image pickup device by the optical path switching mechanism.

In accordance with an eleventh aspect of the invention, the image pickup apparatus according to the eighth aspect further includes incident light amount detection means for detecting an incident light amount onto the image pickup apparatus, wherein the incident light condition detecting means detects the condition of a very small amount of the incident light onto the image pickup device by the fact that a light amount detected by the incident light amount detection means is smaller than a predetermined threshold. In accordance with a twelfth aspect of the invention, the image pickup apparatus according to the first aspect further includes means for uniformly leveling incident light onto the image pickup device to form it into a plane light, wherein the defect pixel detection means detects defect pixels in the condition where a plane light is caused to be incident on the image pickup device by the incident light uniformly leveling means.

In the image pickup apparatus constructed as in the above eighth to twelfth aspects, image pickup signals of which defect detection is easy can be obtained from the image pickup device so that accuracy in the defect detection can be further improved by using such image pickup signals.

In accordance with a thirteenth aspect of the invention, the defect pixel detection means of the image pickup apparatus according to the first aspect is capable of arbitrarily setting the sensitivity for detecting defect pixels.

In thus constructed image pickup apparatus, a defect detection result can be obtained with putting an importance to the influence on appearance.

In accordance with a fourteenth aspect of the invention, the defect pixel detection means of the image pickup apparatus according to the thirteenth aspect is capable of setting the detection sensitivity correspondingly to the location within the image to be taken. In accordance with a fifteenth aspect of the invention, the defect pixel detection means of the image pickup apparatus according to fourteenth aspect is capable of setting the detection sensitivity correspondingly to observed regions for use such as in AF/AE within the image to be taken.

In thus constructed image pickup apparatus, those defects occurring at locations easily detectable by human vision can be detected with priority.

In accordance with a sixteenth aspect of the invention, the defect pixel detection means of the image pickup apparatus according to the thirteenth aspect is capable of setting the detection sensitivity correspondingly to scenes within the image to be taken. In accordance with a seventeenth aspect of the invention, the defect pixel detection means of the image pickup apparatus according to the thirteenth aspect is capable of setting the detection sensitivity correspondingly to frequency components within the image to be taken.

In thus constructed image pickup apparatus, those defects occurring at object patterns easily detectable by human vision can be detected with priority.

In accordance with an eighteenth aspect of the invention, the defect pixel detection means of the image pickup apparatus according to the thirteenth aspect is capable of setting the detection sensitivity correspondingly to image taking conditions for obtaining an image taken by main exposure. In accordance with a nineteenth aspect of the invention, the image pickup apparatus according to the eighteenth aspect further includes means for detecting an image taking exposure time, wherein the defect pixel detection means is capable of setting the detection sensitivity correspondingly to the image taking exposure time detected by the image taking exposure time detection means. In accordance with a twentieth aspect of the invention, the image pickup apparatus according to the eighteenth aspect further includes means for detecting a temperature of the image pickup device, wherein the defect pixel detection means is capable of setting the detection sensitivity correspondingly to the temperature detected by the temperature detection means.

In any of thus constructed image pickup apparatus, the defect detection accuracy can be changed correspondingly to the amount of occurrence of defect pixels by the conditions of image taking environment.

### BRIEF DESCRIPTION OF THE DRAWINGS

FIG. 1 is a block diagram showing an example of construction of the conventional defect pixel detecting/correcting system.

FIG. 2 is a block diagram showing a first embodiment of the image pickup apparatus according to the invention.

FIG. 3 schematically shows essential portions of a second embodiment of the invention.

FIG. 4 is a block diagram showing a third embodiment of the invention.

FIG. 5 is a block diagram showing a fourth embodiment of the invention.

FIG. 6 is a block diagram showing a fifth embodiment of the invention.

FIG. 7 schematically shows essential portions of a sixth embodiment of the invention.

FIG. 8 schematically shows essential portions a seventh embodiment of the invention.

FIG. 9 schematically shows essential portions of a modification of the sixth and seventh embodiments of the invention.

FIG. 10 is a graph showing the relation between a parameter value necessary for defect detection and defect detection sensitivity according to an eighth embodiment of the invention.

FIGS. 11A and 11B illustrate set regions of defect detection sensitivity according to the eighth embodiment of the invention.

FIG. 12 shows in the form of a graph the pixel locations and defect detection sensitivity on the screen frame shown in FIG. 11B.

FIG. 13 shows the manner of dividing into blocks for computing frequency components of image according to a ninth embodiment of the invention.

FIG. 14 is a graph showing the relation between frequency and defect detection sensitivity according to the ninth aspect of the invention.

FIG. 15 is a block diagram showing a tenth embodiment of the invention.

FIG. 16 is a graph showing the relation between the image taking exposure time and defect detection sensitivity according to the tenth embodiment of the invention.

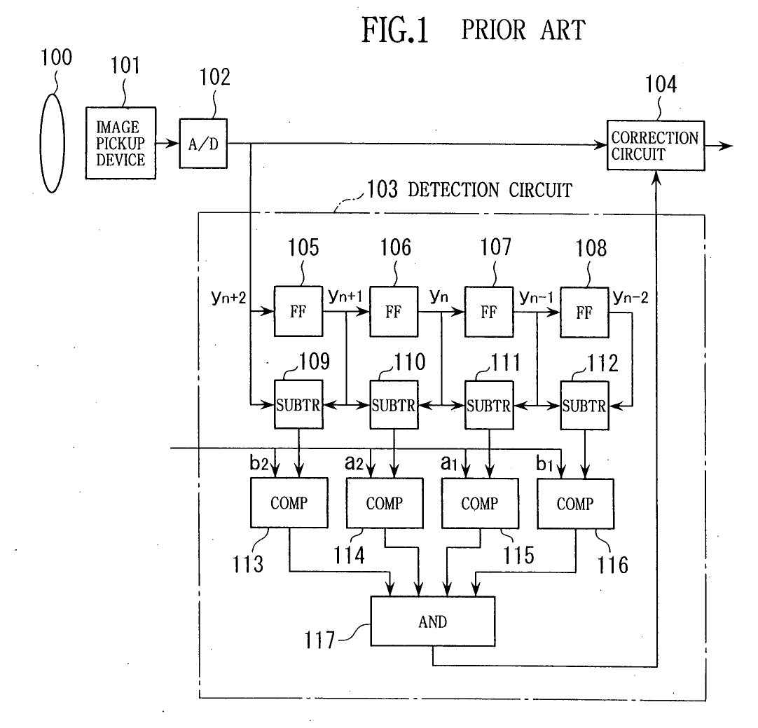

### DESCRIPTION OF THE PREFERRED EMBODIMENTS

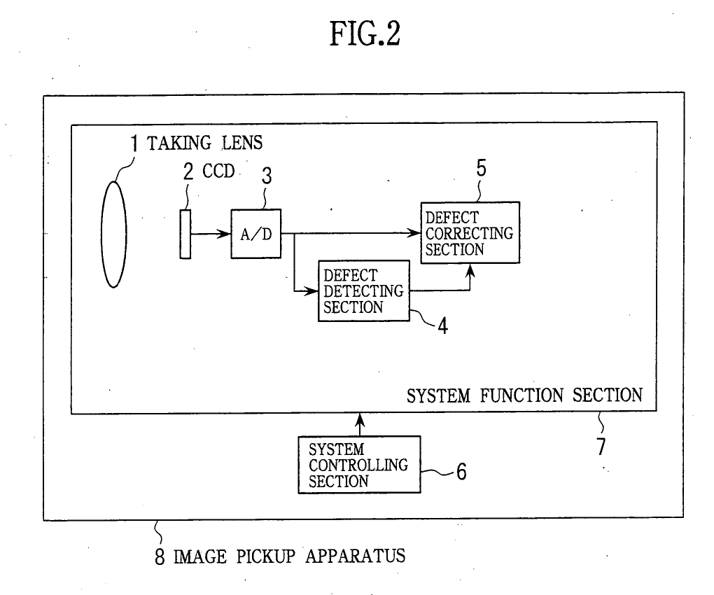

Some embodiments of the present invention will now be described. FIG. 2 is a block diagram showing a first embodiment of the image pickup apparatus according to the invention. The invention is not limited to black-and-white image pickup apparatus and can be applied to any types of image pickup apparatus such as a color image pickup apparatus. For ease of explanation, however, one applied to an image pickup apparatus using a black-and-white CCD image pickup device will be shown in the following embodiments including the present embodiment.

FIG. 2 includes: 1, a taking lens for causing an incidence of object light; 2, CCD image pickup device for converting the object light into electrical signals; 3, an analog-to-digital converter for converting image pickup signals out putted from CCD image pickup device 2 into digital signals; 4, a defect detecting section for detecting defect pixels from the digitized image pickup signals; 5, a defect correcting section for performing correction processing of the defect pixels detected at the defect detecting section 4. Denoted by numeral 6 is a system controlling section for example of CPU for managing the operation of the image pickup apparatus as a whole. For example it performs such system status management as the status management of an external recording medium and also performs setting of various parameters necessary at the defect detecting section 4 and defect correcting section 5. It should be noted that numeral 8 denotes the entire image pickup apparatus and 7 indicates a system function section controlled by the system controlling section 6.

In the image pickup apparatus according to the present embodiment having such construction, when a set status of the system function section 7 is determined by the system controlling section 6 as a timing condition where the photographer has no intention of taking an image, the defect detecting/correcting operation is to be performed by the defect detecting section 4 and defect correcting section 5. The timing without an intention of image taking specifically refers to the timing conditions of a second embodiment and after to be described below. In addition, in the case of image pick up apparatus having a shutter such as a digital camera, it suffices to perform a defect detecting operation at a timing other than that of shutter operation. By thus performing a defect detecting operation when the photographer has no intention of taking an image, the starting time necessary before making photographing possible can be reduced as compared to the method of performing defect detection at every turning-on of the power so as to avoid a missing of image taking chance due to defect detection.

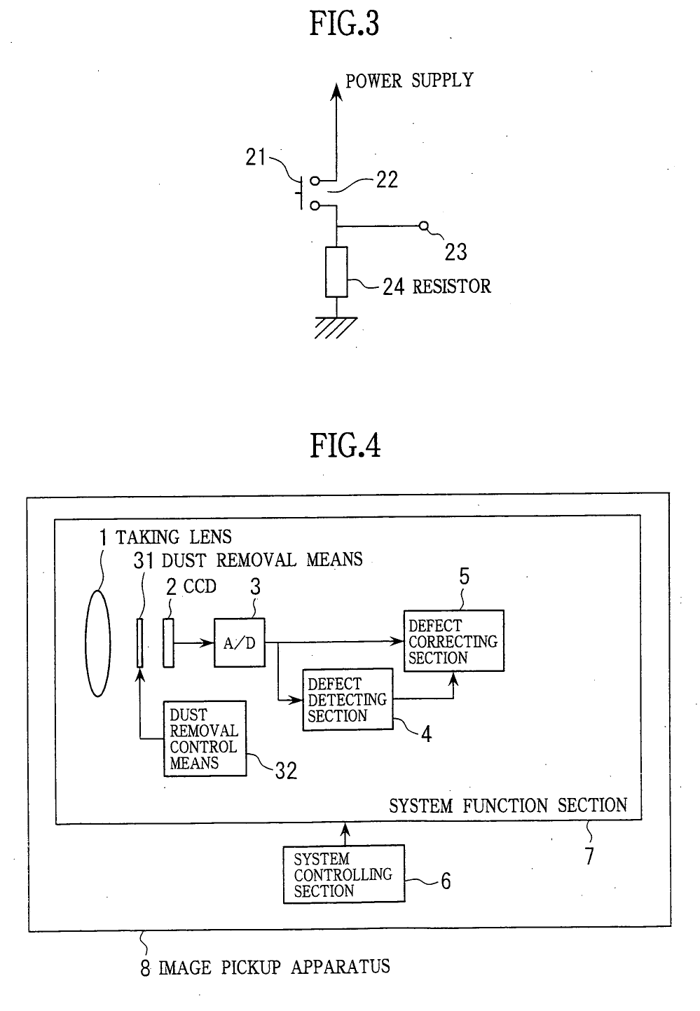

A second embodiment will now be described. In this embodiment, of the first embodiment shown in FIG. 2, the taking lens 1 is constructed in a detachable/reattachable manner and the image pickup apparatus includes a lens attachment/detachment detection means for detecting and recognizing in the system controlling section 6 whether attachment/detachment of the taking lens 1 has been effected. The lens attachment/detachment detection means can be constructed for example as shown in FIG. 3. In particular, a projection such as a press button switch 21 is formed at the taking lens attachment/detachment section. Since the press button switch 21 is pressed to cause short at a contact section 22 when the lens is attached, “H” is outputted to an output section 23 as 1-bit digital signal. When the lens is not attached, on the other hand, the press button switch 21 is opened to break the contact section 22 so as to output “L” to the output section 23 by the resistor 24. At the system controlling section 6, then, such signal from the output section 23 is detected so that the defect detecting section 4 is started to perform a predetermined operation when the power supply is conducted through the system and the detachment of the taking lens 1 has been recognized.

By such construction, since it is not necessary to perform the defect detecting operation frequently at every turning-on of the power of the image pickup apparatus as in the conventional case, a reduction in the power consumption becomes possible and at the same time a missing of image taking chance due to defect detecting operation can be avoided. Further, if the system is constructed so as to turn ON the power of necessary portions for only a predetermined period when the press button switch 21 is opened, it is also possible to cause the defect detecting operation to be performed by recognizing an attachment/detachment of the taking lens even when the power is OFF.

The defect detecting operation then can be performed immediately after a detachment of the taking lens 1. It is also possible to store an attachment/detachment result of the taking lens, i.e., an output of the output section 23 to a 1-bit memory such as of an exclusive EEPROM that is electrically erasable and writable so that information of the above memory is confirmed at the next turning-ON of the power to perform defect detection only when a detachment of the taking lens 1 has been recognized.

Further, the incident light becomes defocused in the condition where the taking lens 1 is detached. Since it is easy to detect an isolated abnormal pixel on the image pickup device 2 in the defocused state, another advantage can be obtained that an accurate defect detection is possible by performing defect detection when the taking lens is detached.

A third embodiment will now be described by way of FIG. 4. In this embodiment, the image pickup apparatus according to the first embodiment shown in FIG. 2 further includes a dust removal means 31 for removing dust adhered to a light receiving surface of the image pickup device 2 and a dust removal control means 32 for controlling the same. Further the system controlling section 6 is provided with a function for detecting/recognizing a dust removing operation of the dust removal means 31.

In the present embodiment, the defect detecting operation is performed immediately after and during the detection/recognition at the system controlling section 6 of a dust removing operation by the dust removal means 31. As the timing of the dust removing operation by the dust removal means 31, it suffices for example to provide at the image pickup apparatus a mode setting means capable of selecting whether or not to perform the dust removing operation so that the operation is performed by the timing at which the photographer has thereby set the dust removing mode.

Further, the possibility of dust adhering to the light receiving surface of the image pickup device is likely to occur after an attachment/detachment of the taking lens is done in an image pickup apparatus having a function capable of attaching/detaching the taking lens. It is therefore also possible to provide the configuration according to the second embodiment shown in FIG. 3 to automatically perform dust removing operation when an attachment/detachment of the taking lens has been detected. Further, since taking of a normal image is likely to be impossible at the time of dust removing operation, a missing of image taking chance just because of a defect detecting operation is avoided by performing the defect detection at such timing.

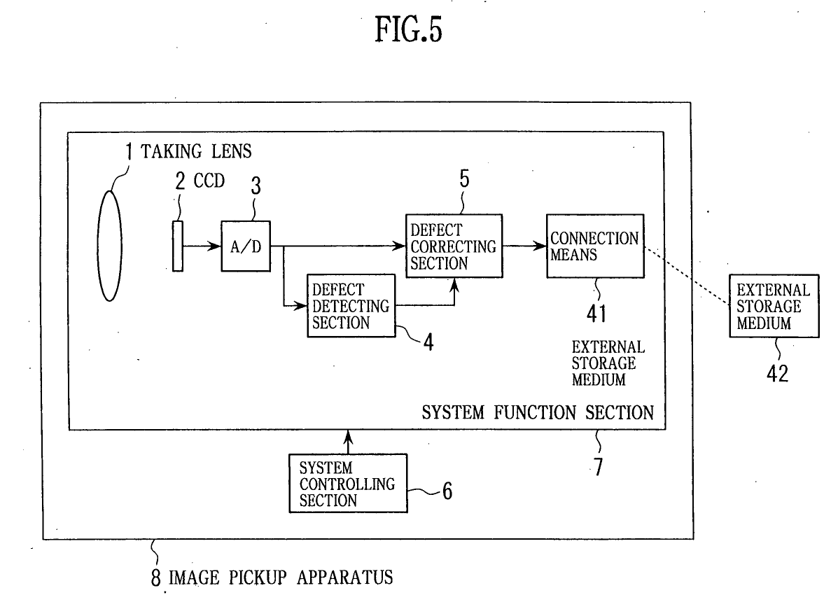

A fourth embodiment will now be described by way of FIG. 5. In this embodiment, the image pickup apparatus according to the first embodiment shown in FIG. 2 further includes a connection means 41 for electrically connecting in a detachable/reattachable manner an external storage medium 42 for recording taken images. The system controlling section 6 is provided with a function for detecting attachment/detachment of the external storage medium 42 to/from the connection means 41 and confirming the storage content of the external storage medium 42. A portable semiconductor memory such as Compact Flash Memory (registered trademark) is used as the external storage medium 42. It is electrically connected at the connection means 41 and is controlled on the image pickup apparatus side.

In the image pickup apparatus according to the fourth embodiment having such construction, when the system function section 7 is performing the setting up operation before image taking to the external storage medium 42, defects are detected: for example, during the confirming operation of whether the external storage medium 42 has been attached or not; when the external storage medium 42 is not yet attached; when the external storage medium 42 is attached and its capacity is being confirmed; or when transmitting data such as a taken image to the external storage medium 42 after confirming blank capacity.

A main image taking is in most cases impossible during performance of the setting up operation to the external storage medium 42. Thus a missing of image taking chance due to defect detecting operation is avoided by performing defect detection necessary for the system function section 7 in such time duration where the image taking is impossible. While various methods can be used to confirm attachment/detachment of the external storage medium 42, it is for example possible to detect a physical contact part in the form of a digital data as the taking lens attachment/detachment detecting section in the second embodiment shown in FIG. 3.

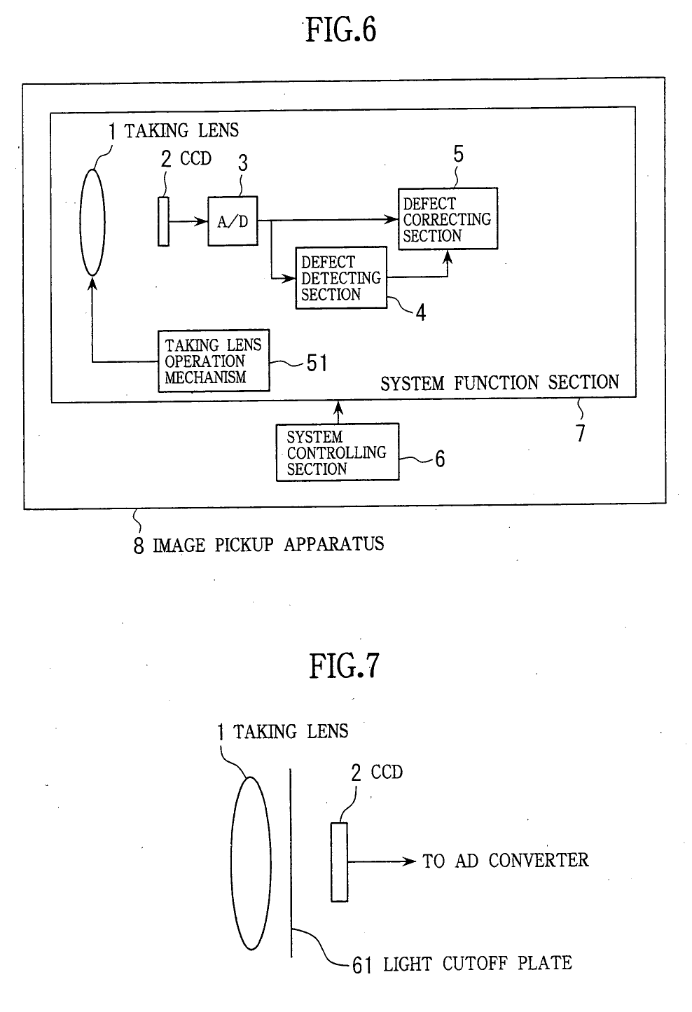

A fifth embodiment will now be described by way of FIG. 6. In this embodiment, the image pickup apparatus according to the first embodiment shown in FIG. 2 further includes an operation mechanism 51 of the taking lens 1. The system controlling section 6 is provided with a function for performing operation control and operation detection of the operation mechanism 51. Here the operation mechanism 51 of the taking lens 1 includes for example a diaphragm operation mechanism or the like in addition to the operation mechanism such as zoom of the taking lens 1 itself.

Setting of view angle and adjustment of exposure amount, i.e., a zooming operation of the taking lens 1 for controlling the view angle and a diaphragm operation for controlling the exposure amount are necessary adjustment items in the setting up of image taking. Image pickup signals in such setting up period for image taking cannot become normal signals. The defect detecting function, on the other hand, is an operation for determining pixel abnormality on the image pickup device unrelated to the object to be taken. Since it does not specifically require a normal object being taken, the defect detection can be performed in such setting up period of image taking. Accordingly, defects can be efficiently detected without missing an image taking chance due to defect detecting operation by detecting the defects at the above described timing during which a main image taking inevitably becomes impossible.

A sixth embodiment will now be described. FIG. 7 schematically shows essential portions of the present embodiment. In this embodiment, a light cutoff plate 61 is placed in front of the image pickup device 2 so that image pickup signals from the image pickup device 2 are obtained in the condition where incident light is cut off by the light cutoff plate 61 to detect defects by using such light cutoff image pickup signals.

Since a light cutoff image results in uniform black level signals, it becomes easy to detect abnormal defect pixels occurring within the image. To obtain the same advantage, it is also possible to detect defects by causing an incidence of uniform plane light or to automatically detect defects at the time of an irradiation of plane light by detecting a uniform plane light on the apparatus side. As a method of detecting plane light, it suffices for example to use the method in which a condition is detected as that of uniform plane light irradiation if the difference between a pixel signal average value of the entire image frame and arbitrary individual pixel signal levels is less than a predetermined level.

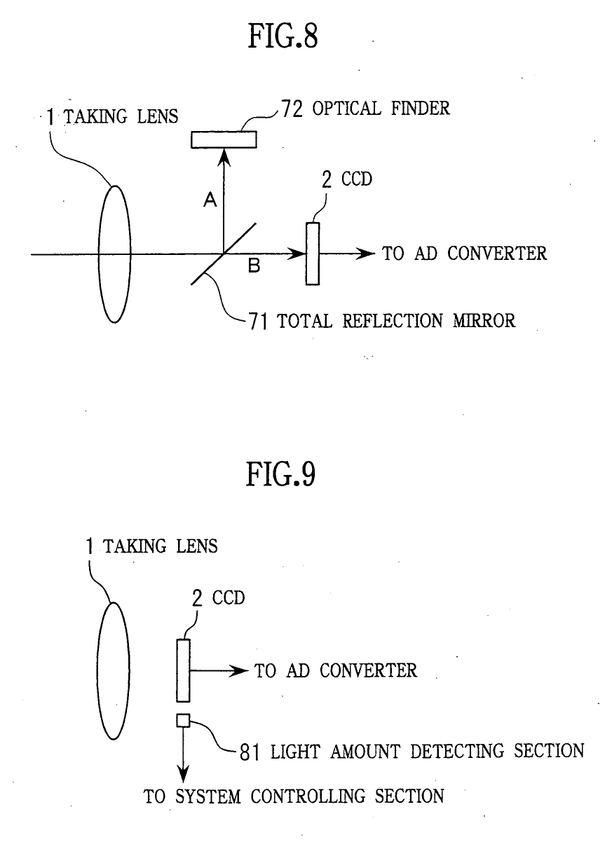

A seventh embodiment will now be described. FIG. 8 schematically shows essential portions of the present embodiment. In the this embodiment, a total reflection mirror 71 is placed in front of the image pickup device 2 so that an object image reflected at the total reflection mirror 71 is guided to an optical finder 72 to be confirmed by the photographer. Here the total reflection mirror 71 is movable so that the total reflection mirror 71 at the time of main exposure image taking is withdrawn from the front surface of the image pickup device 2 to irradiate the total light amount onto the image pickup device 2 through an optical path B. Further, in confirming image taking by the optical finder 72, the total reflection mirror 71 is placed in front of the image pickup device 2 so as to send the total light amount toward the optical finder 72 through an optical path A.

In the image pickup apparatus constructed as the above, inputting of cutoff incident light onto the image pickup device 2 is possible without requiring the light cutoff plate 61 as in the sixth embodiment shown in FIG. 7. An equivalent advantage as the above sixth embodiment can thus be achieved in a small size and low power consumption without requiring the light cutoff plate 61 for the defect detection.

In the above sixth and seventh embodiments, defect detection is performed by producing a condition of very small amount of incident light on the image pickup device 2 by the light cutoff plate 61 or total reflection mirror 71. It is however also possible to perform defect detection by automatically detecting that the amount of incident light on the image pickup device 2 is a suitable incident light amount for performing the defect detection, i.e., it is a scene of the condition where the incident light onto the image pickup device 2 is very small in amount.

For example, an amount of the incident light onto the image pickup device 2 is obtained based on image pickup signals outputted from the image pickup device 2 and such obtained light amount is compared with a predetermined threshold. If smaller than the threshold, the scene is regarded as that of a suitable incident light amount for performing defect detection and the defect detection is performed. This configuration is suitable for the case where the image pickup apparatus 8 employs the system of the so-called “video exposure”.

Alternatively, instead of using the image pickup signals from the image pickup device 2, a light amount detecting section 81 for detecting the amount of incident light onto the image pickup device 2 is provided separately from the image pickup device 2 as shown in FIG. 9 in the vicinity of the image pickup device 2. It is then suffices to determine whether or not to perform defect detection by using detection signals from the light amount detecting section 81. By the above configurations, too, image pickup signals readily capable of defect detection can be obtained from the image pickup device.

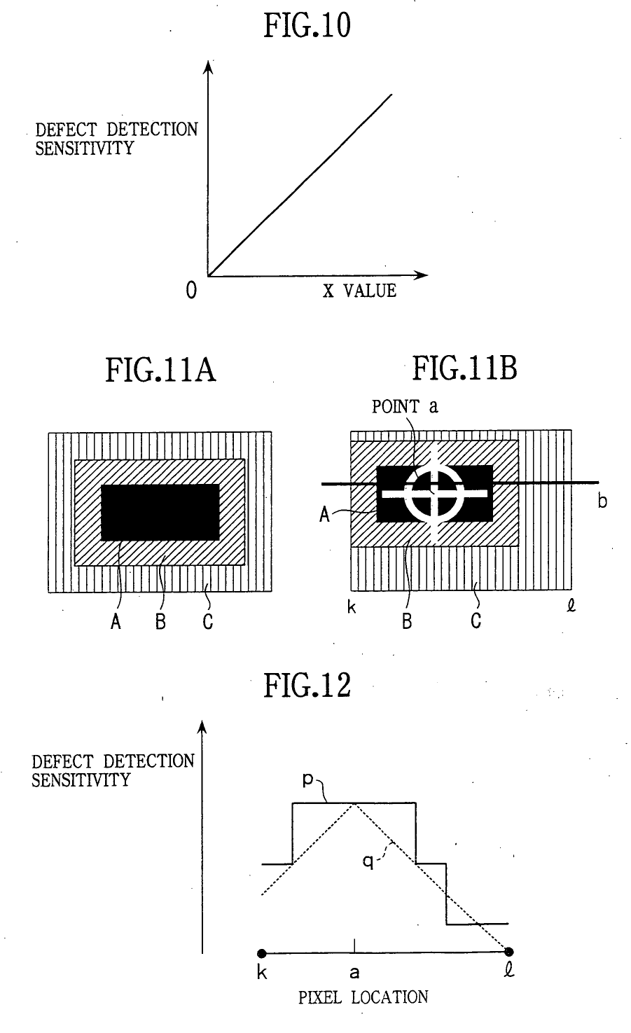

An eighth embodiment will now be described. In this embodiment, of the image pickup apparatus according to the first embodiment shown in FIG. 2, parameters necessary at the time of defect detection at the defect detecting section 4 can be arbitrarily set at the system controlling section 6. Suppose X as the value of parameter necessary for defect detection where, as shown in FIG. 10, the sensitivity of defect detection becomes higher as the parameter value X becomes greater. In FIG. 10, the vertical axis represents the defect detection sensitivity and the horizontal axis represents the parameter value X. Generally, human eyes are necessarily fixed on the portion to be noticed within an image. Accordingly, the sensitivity of defect detection is set by an adjustment of the parameter value X so that a most easily seen image quality is achieved for such noticed portion.

For example as shown in FIG. 11A, the defect detecting sensitivity is higher for a center portion of the image frame and the sensitivity of the peripheral portion is set lower. Further, in the image pickup apparatus where the position to be noticed is designated by the photographer such as spot AE/AF of a digital camera, the sensitivity of defect detection is set correspondingly to the designated spot position for example as shown in FIG. 11B. FIGS. 11A and 11B show an example where the entire screen frame is divided into three regions of A, B, C so that the defect detecting sensitivity is individually set by such regions.

In particular, for example in FIG. 11A, the sensitivity is higher toward the center of the image frame and the sensitivity is lowered toward the periphery. In FIG. 11B, the detection sensitivity in the case of setting spot AE to point “a” is set by division into areas where the point “a” is set as a center so that the sensitivity of the defect detection is lowered toward the periphery of the image. The step-like waveform p shown in FIG. 12 is a graphic representation of pixel locations and detection sensitivity with respect to a horizontal line b in FIG. 11B. The pixel locations a, k, 1 in FIG. 11B correspond to the pixel locations along the horizontal line on the graph of FIG. 12. It is possible either to cause the defect detecting sensitivity to change by each area as the step-like waveform p or to cause the defect detecting sensitivity to change linearly in accordance with the position in the image as the mountain-like dotted line q.

Further, in the case where it is necessary to cause the detected defect location information to remain in a storage section of the image pickup apparatus which is formed mostly of memory, the detected defects, if too many, may exceed the provided memory capacity. In such case, the number of acquired defects can be adjusted by putting priorities on the information of defect locations to be kept in the apparatus so as to weaken the detection sensitivity for those defects located at positions visually not obstructive. It is thereby possible to suitably store defect information in accordance with the capacity of the exclusive storage section.

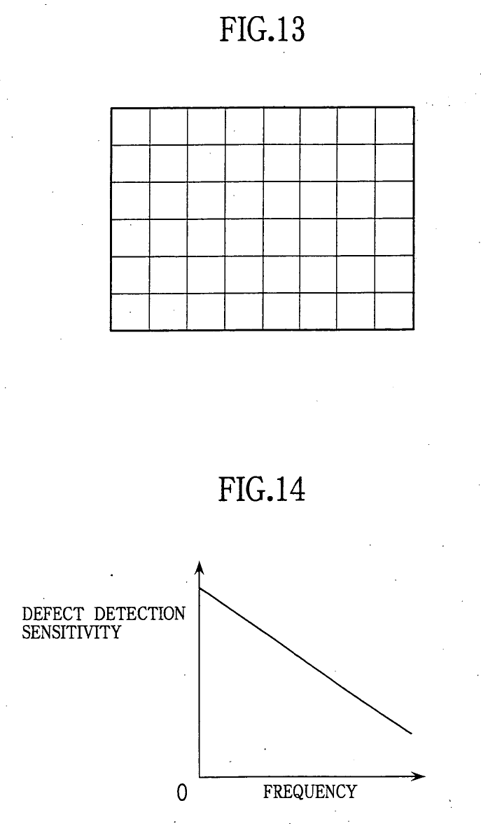

A ninth embodiment will now be described. While in the above eighth embodiment the sensitivity of defect detection is changed corresponding to the location within the image, the present embodiment is constructed so that the sensitivity of defect detection is changed corresponding to the scene to be taken. In particular, an image is divided into predetermined blocks as shown in FIG. 13 so as to compute a main frequency component for each block. In the computation of frequency, it suffices for example to use a method in which Fourier transform processing is performed with respect to image pickup signals after subjecting the image to a high-pass filter processing of specific frequency and the frequency intensity distribution is normalized by a predetermined rule to achieve a representative value.

FIG. 14 is a diagram showing the relation between frequency and defect detecting sensitivity where setting is such that a detection sensitivity of low sensitivity is used for the high frequency portion and detection at high sensitivity is performed for the low frequency portion. For human vision, the defects within a high-frequency scene are more difficult to be detected as compared to defects within a low-frequency scene. Further, when defects are to be detected from an arbitrary scene, while defect detection from a low-frequency scene is easy, it is difficult to detect defects from that of high frequency. In short, detection errors occur more frequently within a high-frequency scene.

Accordingly, a visually most suitable defect detection can be performed without the influence of detection errors by as shown in FIG. 14 performing the defect detection at lower sensitivity for the high-frequency portion and at higher sensitivity for the low-frequency portion. It should be noted that, while in the example shown in FIG. 13 frequency components are computed by dividing the image into blocks so as to set a sensitivity of defect detection for each block, a detection sensitivity can also be set by computing a frequency component for each one frame of image. Further, it is also possible to use a frequency value of a predetermined area to be observed as a representative value of frequency of the image as a whole. Also, of the image scenes, the defect detection can be performed with a priority on a certain color region predominated by a color of the kind causing an unconscious gaze of human eyes such as a skin color.

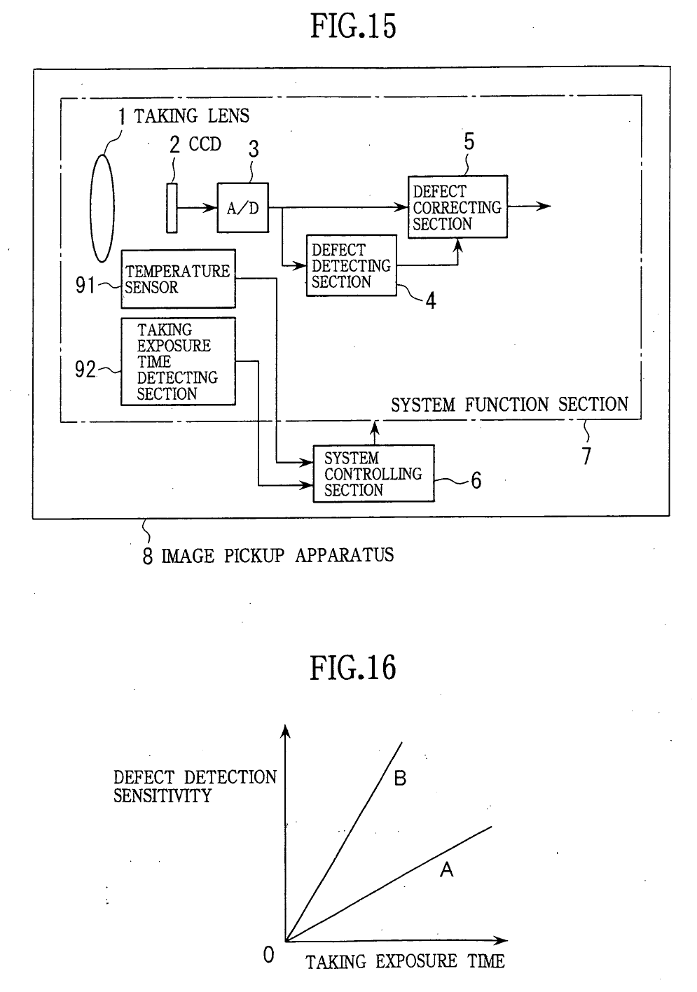

A tenth embodiment will now be described. While in the above ninth embodiment the defect detection sensitivity is set corresponding to the image scenes, the sensitivity of defect detection in the present embodiment is set according to the image taking conditions. FIG. 15 is a block diagram showing configuration of the present embodiment where a temperature sensor 91 and an image taking exposure time detecting section 92 are disposed in the vicinity of the image pickup device 2 in addition to the construction of the first embodiment shown in FIG. 2. Some defect pixels occur transiently. These are caused by variance in dark current components of the solid-state image pickup device. The dark current components are the noise components depending on temperature and time and are increased in level as the temperature becomes higher and as the image taking exposure time becomes longer. The variance of pixel level correspondingly becomes larger so that the number of the pixels of the level recognized as defect is increased within the image.

In a system having an algorithm capable of detecting defects suitably to an arbitrary scene, on the other hand, since the accuracy of the algorithm of defect detection depends largely on the scene to be taken, such detection errors as the detection of normal pixels as defects or not detecting defect pixels are caused to occur. Thus the defect detection error can be suppressed and it becomes possible to take an image of higher quality by causing the defect detection sensitivity to change correspondingly to temperature and image taking exposure time of the image pickup device 2 which are main factors affecting the amount of such occurrence.

A temperature of the image pickup device 2 is measured by the temperature sensor 91 and an information of the image taking exposure time is obtained by the image taking exposure time detecting section 92. Both are transmitted to the system controlling section 6 for managing the setting of the sensitivity of defect detection, i.e., parameters necessary for the defect detection. At the system controlling section 6, parameters of defect detection are set on the basis of these information to finally determine the sensitivity of defect detection.

FIG. 16 is a graph showing a relationship set between the temperature and image taking exposure time and the defect detection sensitivity. Since the amount of occurrence of defects is increased as the image taking exposure time becomes longer, a higher defect detection sensitivity is set. Also, since the amount of occurrence of defects is increased as the temperature becomes higher, the set conditions may be changed according to the temperature for example as straight line A for low temperatures and straight line B for high temperatures. While the relation between the defect detection sensitivity and the parameter affecting the same in the above ninth and tenth embodiments is represented by a linear straight line as shown in FIGS. 14 and 16, it is naturally also possible to be adjusted to a predetermined tone curve such as a curve of second degree or γ curve on the indicating instrument side.

As has been described by way of the above embodiments, it is possible according to the first aspect of the invention to reduce power consumption and starting time necessary before making image taking possible as compared to the method where defects are detected at every turning-on of the power so that the operability can be improved with avoiding a missing of image taking chance due to the defect detection.

According to the second and third aspects of the invention, the defect detecting operation is performed less frequently than the turning-on of the power so that the operability is improved and a reduction in the power consumption becomes possible. According to the fourth to seventh aspects of the invention, defects can be detected at some times other than the image taking operation intended by the photographer without any connection to the turning-on of the power so that an efficient defect detection can be performed without a missing of image taking chance due to defect detection. According to the eighth to twelfth aspects of the invention, image pickup signals readily capable of defect detection can be obtained from the image pickup device and these can be used to further improve the accuracy in defect detection.

According to the thirteenth aspect of the invention, a defect detection result can be obtained with putting an importance to the influence on appearance. According to the fourteenth and fifteenth aspects of the invention, those defects occurring at locations easily detectable by human vision can be detected with priority and the size of information on defects can be adjusted. According to the sixteenth and seventeenth aspects of the invention, those defects occurring at object patterns easily detectable by human vision (conspicuous scenes) can be detected with priority and the amount of information on defects can be adjusted. According to the eighteenth to twentieth aspects of the invention, the defect detection accuracy can be changed correspondingly to the amount of occurrence of defect pixels by the conditions of image taking environment and the amount of information on defects can be adjusted.

What is claimed is:

1. An image pickup apparatus comprising:
a taking lens;
an image pickup device;
defect pixel detection means for detecting defect pixels occurring on the image pickup device; and
incident light condition detecting means for detecting the condition of incident light onto said image pickup device,
wherein said defect pixel detection means detects defect pixels in a time period during which an image taken by main exposure requiring a recording by said image pickup device cannot be obtained, and
wherein said defect pixel detection means detects defect pixels when a condition that light incident on said image pickup device is very small in amount is being detected by said incident light condition detecting means.

2. The image pickup apparatus according to claim 1 further comprising:
light cutoff means for cutting off incident light onto said image pickup device,
wherein said incident light condition detecting means detects the condition of a very small amount of the incident light onto said image pickup device by condition where light is cut off by said light cutoff means.

3. The image pickup apparatus according to claim 1 further comprising:
a mechanism capable of switching the optical path of the incident light onto said image pickup device,
wherein said incident light condition detecting means detects the condition of a very small amount of the incident light onto said image pickup device by the fact that the optical path is being switched to an optical path different from the optical path to said image pickup device by said optical path switching mechanism.

4. The image pickup apparatus according to claim 1 further comprising:
incident light amount detection means for detecting an incident light amount onto said image pickup apparatus,
wherein said incident light condition detecting means detects the condition of a very small amount of the incident light onto said image pickup device by the fact that a light amount detected by said incident light amount detection means is smaller than a predetermined threshold.
